(19) United States
(12) Patent Application Publication
(10) Pub. No.: US 2017/0285219 A1
(43) Pub. Date: Oct. 5, 2017

(54) METHOD OF DETERMINING THE CONDITION AND POSITION OF COMPONENTS IN A COMPLETION SYSTEM

(71) Applicant: Schlumberger Technology Corporation, Sugar Land, TX (US)

(72) Inventors: Dominic Joseph Brady, Dhahran (SA); Ali Bin Al-Sheikh, Dammam (SA); Christian Stoller, Princeton Junction, NJ (US)

(21) Appl. No.: 15/086,238

(22) Filed: Mar. 31, 2016

(51) Int. Cl. G01V 5/10; E21B 34/06; E21B 47/09; E21B 33/12

(52) U.S. Cl. CPC G01V 5/102; E21B 33/12; E21B 34/06; E21B 47/09

(57) ABSTRACT

Methods may include detecting the presence of a component in a wellbore including irradiating an interval of a wellbore containing one or more components of a wellbore tool with a neutron source, wherein the one or more components of the wellbore tool comprise one or more tracer materials; measuring the radiation emitted from the one or more components of a wellbore tool; determining one or more of presence, location, and intensity of the radiation emitted from the one or more components of the wellbore tool. Devices may include a first element comprising one or more tracer materials, wherein the one or more tracer materials emit gamma radiation upon irradiation with a neutron source; wherein the tool is configured to be emplaced in a subterranean formation.

### BACKGROUND

After an oil or gas well has been drilled, completions operations are undertaken to create a flow path for hydrocarbons to reach surface. During completion operations, production liners may be cemented into place to seal off drilled rock formations from the wellbore. In addition, a number of tools and completion strings may be placed into the wellbore that may contain various elements including packers, articulable sleeves, and valves. Completion systems have tended toward becoming more complex, in order to introduce granularity and increased operator control during hydrocarbon extraction from reservoirs. However, inaccurate placement of completion tools may result in damage to the well and/or hydrocarbon bearing rocks, which can result in a section of the well being abandoned or re-drilled. Location of completion tools in their intended downhole locations may involve estimation, operator experience, and the utilization of various techniques that rely on changes in surface loading that become less reliable as wells deviate from the vertical.

For mechanical tools, attempting to force the desired downhole movement without the ability to measure and see the loads being created may lead to tubular buckling, or mechanical damage to components of the drill pipe string including packers or other completion tools. Location of equipment during completions operations is further complicated by changes in pipe length that may occur during emplacements. Long, deviated, or horizontal wells in particular are susceptible to pipe stretch and compression, which may occur if piping encounters friction and other stresses. Activation of tools may also induce length changes. For example, pressure and temperature changes can change the diameter tubing, which can result in length changes that can be on the order of tens of feet and can shift completion tools from expected placement positions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure are directed to methods of detecting the presence of a component in a wellbore that include irradiating an interval of a wellbore containing one or more components of a wellbore tool with a neutron source, wherein the one or more components of the wellbore tool comprise one or more tracer materials; measuring the radiation emitted from the one or more components of a wellbore tool; determining one or more of presence, location, and intensity of the radiation emitted from the one or more components of the wellbore tool.

In another aspect, embodiments of the present disclosure are directed to devices that include a first element comprising one or more tracer materials, wherein the one or more tracer materials emit gamma radiation upon irradiation with a neutron source; wherein the tool is configured to be emplaced in a subterranean formation.

Other aspects and advantages of the invention will be apparent from the following description and the appended claims.

### BRIEF DESCRIPTION OF FIGURES

FIG. 1 is an illustration of a completions system in accordance with embodiments of the present disclosure;

FIGS. 2 and 3 are illustrations of a downhole logging tool in accordance with embodiments of the present disclosure;

FIGS. 4 and 5 are illustrations of the operation of a sensor in accordance with embodiments of the present disclosure; and

FIG. 6 is an illustration of a valve seat in accordance with embodiments of the present disclosure.

### DETAILED DESCRIPTION

Embodiments of the present disclosure are directed to methods and tools that incorporate non-radioactive elemental tracer materials that may be detected by measuring the gamma ray emission of the materials following inelastic neutron interaction or neutron capture. In one or more embodiments, materials and tools in accordance with the present disclosure may be used in completions systems to identify the relative location of individual components and, in some cases, may be used to study downhole conditions, verify system configurations, and to detect system faults. In some embodiments, tracer materials in accordance with the present disclosure may emit characteristic gamma radiation upon irradiation with a neutron/nuclear tool passing through the completion string, which may allow the detection of tracer material labelled components within a completion system, even where the components are colocalized.

During completions operations, components installed may include liner systems, production packers, subsurface flow controls, and subsurface safety valves. Modern completion systems may also incorporate both sensing and control systems, inflow control devices (ICDs), flow control valves (FCVs), pressure gauges, and control lines that may allow operators to drain their reservoirs with a greater degree of granularity and may provide an increased understanding of fluid movement and reservoir drainage. However, as completions systems become more complex it may become more difficult to detect and remediate non-conformities and failures that may arise from eroded valves, fixed or stuck valves, and failed control lines. In systems with limited numbers of control lines, the failure of a single line may impair the ability to troubleshoot faulty system components, or in some cases even detect the current status without pulling the completion system. In addition to hard failures that result in system inoperability, there also exists a range of soft failures such as leaking hydraulic systems and valve seats, erosion of valve components, and other instabilities that may occur with high flow rates, high choke, or ingress of abrasive or corrosive fluids, which may impair system control without being readily detectable.

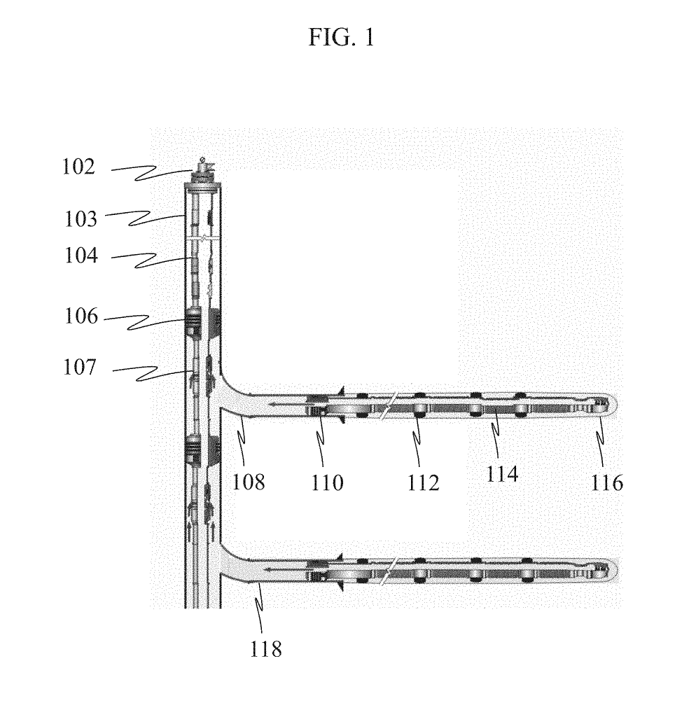

With particular respect to FIG. 1, a completions system in accordance with the present disclosure is shown. Following cementing and emplacement of casing sections 103, one or more liners 108, and well head 102, one or more completion strings may be installed depending on the number and complexity of the potential reservoirs within the formation. Completion systems in accordance with the present disclosure may include one or more pressure relief valves 104 and safety and isolation devices such as removable/retrievable hydraulic packers 106 and flow control valves 107. Isolation devices may be passive or controlled by an operator at the surface using one or more control lines (not shown). Completions systems may utilize multi-zone modular completion strings 110 that are installed following drilling and cleaning operations. Completion strings 110 may include one or more isolation packers 112. The intervening string sections 114 between multiple isolation packers may include a number of functionalities including sliding sleeves and/or sand screens to capture hydrocarbons from the formation. The completions string may terminate at 116 with a re-entry guide, drill bit, or other appropriate tool. Completion systems in accordance with the present disclosure may be used within vertical or deviated wellbores, and may also be employed in systems having any number of additional multilateral wells and completions strings as shown in 118.

Embodiments in accordance with the present disclosure are directed to the use of tracer materials to label wellbore tools and components to aid placement and subsequent location and identification downhole. In some embodiments, methods in accordance with the present disclosure may be used to detect the location and condition of selected components within the completion string, such as valve position, the condition of valve seats or controlling faces, control line status, the azimuthal location of control lines or other equipment, the status of the interior of pressure barriers that may protect electronics and other components, and the relative positioning of completion components, such as inductive couplers, or packer-setting components. Tools and methods in accordance with the present disclosure may represent a relatively low-cost addition to the up-front cost of a completion system yet provide information that may assist remedial actions when adverse conditions are detected, and may obviate the need to remove the completion system, such as when completed sections remain intact and demonstrate well integrity.

In one or more embodiments, tracer materials may be incorporated into sensors that may be used to detect a variety of downhole conditions. Sensors in accordance with the present disclosure may be deployed within the completion structure, which may be configured to provide, in addition to the general spatial positioning of the element, information regarding conditions present in the wellbore including pressure, temperature, pH, and corrosive conditions. For example, in embodiments in which a sensor is configured to detect pressure changes, the sensor may be used to detect leaks or instances when the pressure exceeds a predetermined maximum or minimum threshold.

Methods of incorporating tracer materials into wellbore tools and components may include integrating one or more tracer materials into a wellbore component as an alloy of the metal used to construct the component structure or as a constituent of a coating on or layer within the component, through ion implantation, installed as a small slug, button, or poppet, or other techniques such that the tracer material is present in an amount that the presence or absence of the tracer is determinable in accordance with methods of the present disclosure.

Methods of detecting tracer materials in accordance with the present disclosure may include exciting the tracer material using radiation from a neutron source, detecting the emitted gamma ray signal from the tracer material, and correlating the gamma ray signal with depth. In some embodiments, once a tracer material has been excited using a neutron source, the fast decay of neutron population may indicate that the tracer material is present, while slow decay may indicate that the material is absent or, in some embodiments, that the component containing the tracer material has degraded or is configured incorrectly.

Methods of inducing radioactivity in tracer materials in accordance with the present disclosure may involve passing a neutron generator through a completion string and irradiating the structure with high energy neutrons, which may activate components containing tracer materials present in one or more elements of the completion string. In some embodiments, gamma ray emission may be induced in tracer materials by 14-MeV neutrons emitted from a neutron source. Neutrons can penetrate various thicknesses of steel, which may allow for the interaction of neutrons with the tracer materials, and subsequent emission of gamma radiation, through casings and/or pressure housings and back to a detector. Methods in accordance with the present disclosure may involve neutron tools that are sized for use in completion systems. These tools come in a range of diameters including 1 11/16″ and 2½.″

In one or more embodiments, tracer materials may be excited using a neutron pulsing scheme, in which neutrons may be emitted into the formation for a specific amount of time, during which the dominating mechanism of generating gamma radiation is through inelastic scattering or high energy neutrons induced nuclear reactions. As the neutrons slow down, eventually to thermal energies, neutron capture reactions become dominant. Neutron capture refers to an interaction in which a neutron is absorbed by the nucleus of a target element, producing an isotope in an excited state. The activated isotope then de-excites through the emission of characteristic gamma rays.

Neutron interactions with tracer materials in accordance with the present disclosure may produce inelastic gamma-rays and neutron capture gamma-rays while the neutrons are being emitted into the formation and for a short time afterward. The presence of the gaps between neutron pulses in the neutron pulsing scheme may allow for distinguishing between time for the inelastic gamma-rays and neutron capture gamma-rays. Creation of inelastic gamma rays may happen during the neutron burst from the source, as the high energy neutrons lose most of their energy in about 1 microsecond or less. During or shortly after the neutron burst, gamma rays may be generated from the capture of slow neutrons, which may then die away within a millisecond or so. If there is a pause between bursts that exceeds about 3 ms, the remaining gamma radiation comes from the activation gamma-rays from the surrounding activated nuclei. The activation gamma-rays may then be detected during the delay, rather than at a later time when the neutron source has been moved away. In some embodiments, methods may also enable the measurement of inelastic gamma-rays and/or neutron capture gamma-rays in conjunction with the activation gamma-rays.

In one or more embodiments, multiple tracer materials may be selected for incorporation into the same or differing components of a wellbore tool. In addition, tracer materials may be selected such that the gamma radiation emitted from each of the tracer materials is distinguishable when detected, which may enable unambiguous detection and location of each tracer material, even where the materials are colocalized.

In some embodiments, wellbore tools in accordance with the present disclosure may be disposed on a control line, small-diameter hydraulic lines used to operate downhole completion equipment such as a surface controlled safety valve, emplaced within a wellbore in order to monitor the operation of the control line and/or conditions within the well. Most systems operated by control line operate on a fail-safe basis. In this mode, the control line remains pressurized at all times. Any leak or failure results in loss of control line pressure, acting to close the safety valve and render the well safe. Methods in accordance with the present disclosure may enable location of failures with increased accuracy, particularly in cases in which the control line serves multiple valves or spans long distances.

In one or more embodiments, gamma radiation detected at a given location may be used to identify the tracer materials present following excitation with a neutron source. Further, the gamma radiation intensity profile detected may be recorded as a function of depth, which may be used to determine the location of the gamma signal and the labelled component. In some embodiments, detector measurements may be tuned for a shallower depth of investigation through gamma ray detector spacing and/or selection of the time gate of the capture data acquisition.

Tracer materials in accordance with the present disclosure may be detected using gamma radiation signatures for the thermal neutron capture cross section (or sigma measurement) to detect the presence of a material with a large thermal neutron capture cross section. Methods in accordance with the present disclosure may use a pulsed neutron source to obtain sigma measurements by determining the die-away of thermal neutron flux or capture gamma ray intensity following a neutron pulse. Sigma measurements determine the cross section for the absorption of thermal neutrons of a volume of matter measured in capture units (c.u.), which may also be correlated to depth as a sigma log in some embodiments. Methods in accordance with the present disclosure may use sigma measurements to detect the absence or displacement of a tracer element. Sigma measurement may be accomplished either by measuring the die-away of the capture gamma rays or thermal neutrons. In some embodiments, measurements based on the detection of thermal neutrons may interrogate a shallower depth relative to nuclear measurements based on the detection of gamma rays, which may decrease the interference from other materials in the surrounding formation. In embodiments utilizing sigma measurements, tracer elements may include boron, cadmium, gadolinium or lithium, for example. In some embodiments, tracer elements may also be enriched in a particular isotope to increase contrast and signal intensity.

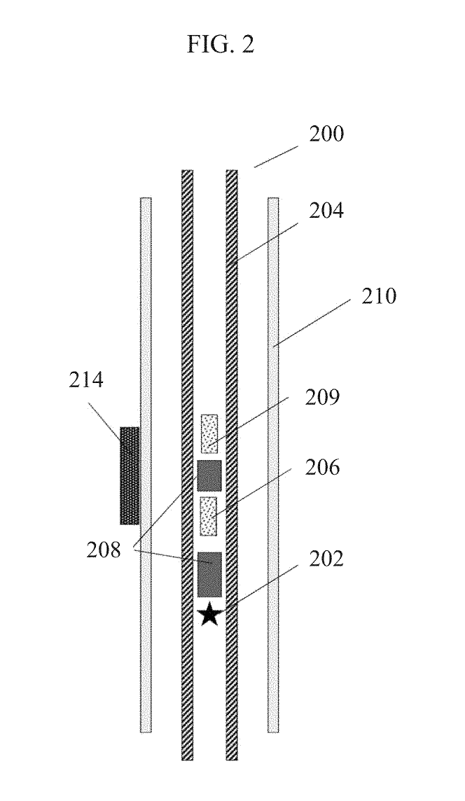

In one or more embodiments, tracer materials may be activated and detected using a downhole neutron-gamma tool. FIG. 2 shows an example of a neutron-gamma tool 200 for use in cased or open hole, which includes a neutron source 202 installed in a tool housing 204. A gamma ray detector 206 is installed at an axial distance from the source 202 and shielded from direct radiation by shielding material 208. The shielding 208 may be made of a heavy metal or may contain neutron-moderating or neutron-absorbing materials. The tool 200 is centered in the casing 210 so as to have equal sensitivity to radiation from all azimuthal directions. The neutrons emitted by the source will interact with materials surrounding tool 200, including completion component 214 that contains one or more tracer materials.

Neutron-induced gamma radiation may contain signatures or spectral features that are unique for a given element or isotope, which may stem from inelastic gamma rays, capture gamma rays, or gamma rays emitted from radioactive isotopes produced by the associated neutron interactions. For example, following neutron irradiation, the tracer materials in the completion component 214 may emit gamma radiation that may uniquely identify the tracer material and the corresponding component 214. In particular, the tracer material in component 214 may emit gamma rays with a characteristic spectrum that distinguishes them from other gamma rays and allows the identification of the presence and axial position of the component. As mentioned previously, the presence of the tracer elements in the component 214 may also lead to an increase in the thermal capture cross section (Sigma).

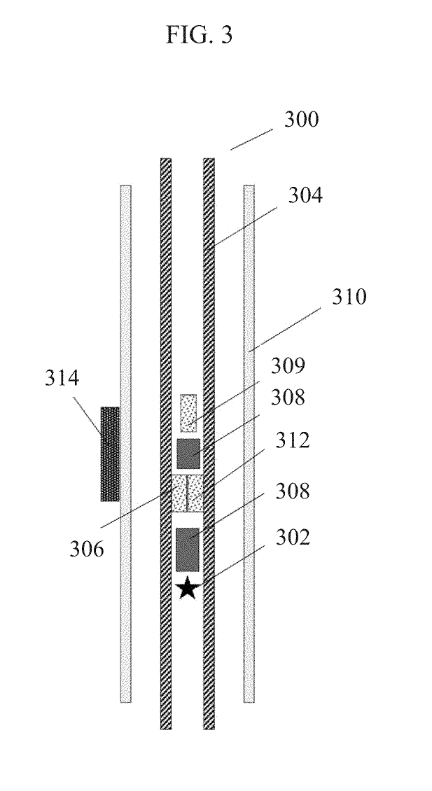

With particular respect to FIG. 3, another embodiment of a neutron-gamma tool is shown. In addition to the one or more detectors at 306, one or more additional detectors 312 may be placed at the opposite side of the tool 300 from the neutron source 302 or at least at an azimuth, where the detector may encounter less interference from the gamma rays emitted from the tracer materials 314 following the interaction with neutrons from the neutron source 302. One or more back detectors 312 may be placed at the same axial distance from the source as the short spaced detector 306. The one or more detectors 312 may be used to measure the gamma rays induced in the material surrounding the tool 300 so that, with proper scaling, the corresponding signal can be subtracted from the signal registered in the detector 306. The azimuthal sensitivity of detector 306 and the one or more detectors 312 may be further enhanced by placing shielding (not shown) between detectors 306 and 312. In embodiments in which multiple detectors are used, such as 306 and 312, the detectors may be mutually shielded.

Determination of the azimuthal orientation of tool such as 200 or 300 may be more complicated in applications in which the tool is conveyed downhole by cable because of the tendency for the tool to rotate. In one or more embodiments, detectors 306 and 312 may be mounted at two or more azimuths in the tool. For an absolute determination of azimuth, the tool 300 or another tool in the tool string may be equipped with a sensor that can determine the azimuth of the tool and/or detectors. In some embodiments, markers in the completion system, such as magnetic or radioactive tags, may also be used to determine the tool's azimuth. Alternatively or additionally different tracer materials described in the subject disclosure may be placed at different azimuths in order to allow determination of the azimuthal orientation of the tool and its detectors

Tool measurement results may be further enhanced by positioning additional detectors 309 and, optionally, corresponding back detectors (not shown) at one or more additional axial distances from the source 302. In order to enhance precision, more than one detector 306 and 309 may be placed at spaced azimuths at the short spaced and long spaced positions from the source 302. Shielding may be added between multiple detectors 306 or 309 azimuthally to enhance the azimuthal resolution of the detectors and to reduce the probability of signals from a single gamma ray in more than one detector. In some embodiments, electronic anticoincidence circuitry may be used to achieve the latter goal.

In one or more embodiments, the neutron source and/or detectors may be conveyed in the borehole by wireline, slickline, coiled tubing, drill pipe, and similar techniques. In some embodiments, wellbore tools may be able to communicate with the surface through telemetry. For example, if a tool is conveyed on drill pipe of coiled tubing it may be possible to rotate the tool in the direction of a preferred azimuth.

In one or more embodiments, methods and tools in accordance with the present disclosure may be combined with detectors modified to determine the azimuthal orientation of directional features and components within the reservoir. Azimuthal detection may be accomplished using back-shielded detectors to measure gamma radiation emitted from an excited tracer material, which may also involve detectors having a mechanism that permits rotating the detectors in order to scan multiple azimuths. Further, gamma ray or neutron detectors may be collimated using appropriate shielding materials in order to increase vertical or azimuthal resolution. In some embodiments, azimuthal detection may be implemented by centering the neutron source in the borehole, while measuring gamma radiation with at least one rotating detector.

When a tool with azimuthal sensitivity is deployed, the addition of doping onto components could be used to determine the azimuthal location of these components. For example, azimuthal measurements may be useful to detect the position of elements such as control lines, or some inflow control devices in which rotation of components is used to set the choke orifice. In order to perform azimuthally sensitive measurements, detection tools may be designed in some embodiments to centralize the tool in the completion system, providing a mechanism to rotate the detector system, and shielding the detector from induced gamma radiation from certain azimuths, such as by incorporating tungsten on one side of the detector. In one or more embodiments, multiple fixed detectors may be employed to provide azimuthal coverage of the interior of the completion system without requiring tool rotation. In some embodiments, the fixed detectors may also be designed such that heavy metal shielding may be rotated about the detector during measurement.

Completion systems in accordance with the present disclosure may be configured to perform a number of measurement functions, including maximum and minimum measurements as discussed above, in addition to a number of real-time measurement configurations. Various embodiments of possible sensors are discussed in the following sections.

### Component Location and Depth Measurement

In one or more embodiments, components containing tracer materials may be used to measure the total depth of the tracer material labelled component and/or the distance between labelled elements within a completion system. In some embodiments, methods in accordance with this disclosure may use a reference marker that defines a particular location on the completion string, from which the minimum and maximum location of one or more tracer material doped components is known. For example, tracer material-labelled components may be used to determine the relative location of inductive couplers, clamps, and index casing coupling profiles present in a multilateral well.

Reference markers in accordance with the present disclosure may also be a different material than other tracer materials used in a given completions system, and which has a unique gamma ray signature. In some embodiments, reference markers may contain a predetermined sequence of tracer material types and locations, which may function as a neutron-activated radioactive “barcode” to identify the location of specific components within the wellbore and, as an example in the case of multilateral wells, confirmation of which wellbore the tool currently resides.

In one or more embodiments, reference markers may allow precise positioning of the neutron source before subsequent irradiation steps, eliminating any potential damage to delicate parts of the completion system. For example, the reference marker could be a marker that relies on a mode of detection that varies from tracer materials in accordance with the present disclosure such as magnetic markers, a gamma ray PIP tags or other small radioisotopic source that may be detected by a gamma ray detector. In some embodiments, reference markers may be identified by a change or sequence of changes in casing inner diameter, detectable by a caliper tool, such as a mechanical or ultrasonic caliper, or other similar mechanical device capable of detecting casing diameter.

### Single-Shot Measurement of Pressure, Water or Oil Exposure

In one or more embodiments, completion systems in accordance with the present disclosure may incorporate sensors to measure and log internal pressure at one or more locations in the system. Pressure monitoring in completions systems, including maximum pressure and fluid type exposure for individual components, may be used to detect events of electrical or hydraulic failure. For example, the presence of pressure or exposure to excess pressure and fluids can be very damaging to internal components such as electronics, seals, and structural components, which may result in electrical shorts, corrosion, and crush failures. By incorporating monitoring techniques in accordance with the present disclosure, stresses on the interior of completion components may be detected and recorded, to enable recovery plans to be developed by identifying failure modes within the system.

In one or more embodiments, wellbore sensors may be configured to measure one or more of maximum, minimum and current position of a downhole actuator. In one or more embodiments, a tool may be designed in which the mechanism of operation relies upon detecting the relative displacement between a mobile piston element doped with, or fabricated from, a tracer material, and a reference element that contains a tracer material that is identical to that of the mobile element or a second unique tracer material.

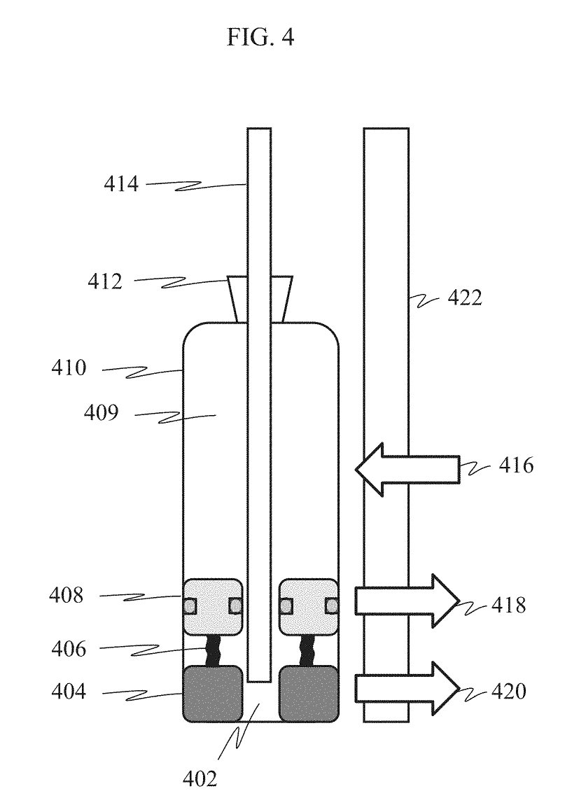

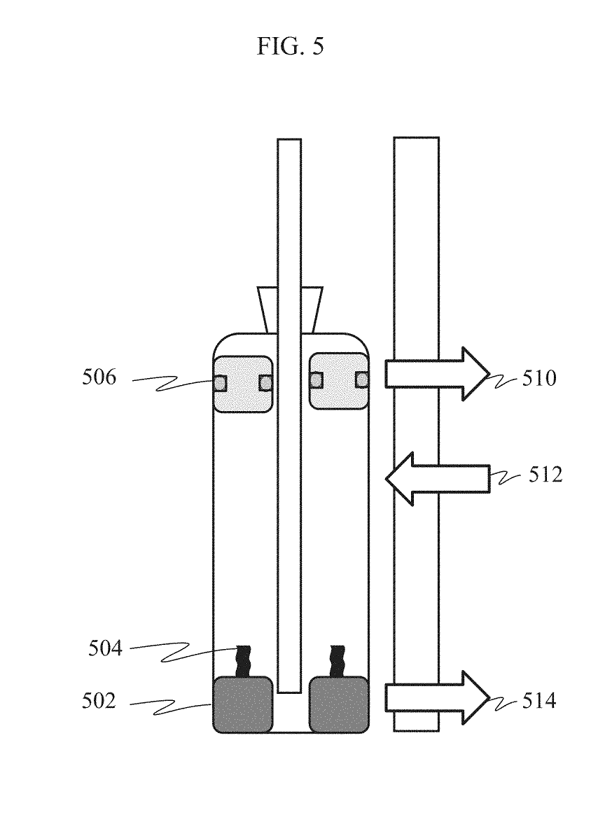

With particular respect to FIGS. 4-5, an example of a sensor configured in accordance with the present disclosure is shown. In FIG. 4, a sensor is shown disposed on a control line 414 attached by a control line seal to the sensor housing at 412. Within the receiving chamber 410, tracer material containing piston elements 408 and 404 are shown in a first position connected by a burst element 406. In some embodiments, the mobile piston element 408 may be held in place by a mechanism that uses a burst element or burst retaining pin which is designed to fail when specific conditions or a specific combination of conditions at the system are met. Failure modes may include failure under loads produced by axial forces or pressures within the sensor, failure at temperatures that change the phase or softens the burst element, failure upon contact with hydrocarbons or water, and failure on contact with specific chemicals, acid, alkali, or gases such as hydrogen sulfide, carbon dioxide, or hydrogen. For example, burst elements in accordance with the present disclosure may be designed to degrade in the presence of one or more of temperature, water exposure, hydrocarbon exposure, and pH change.

Sensors in accordance with the present disclosure may contain one or more ports at 402 that allow fluid or gas communication between the interior and exterior of the sensor. During measurement, a downhole neutron source may excite the tracer materials in elements 408 and 404 by emitting neutrons 416 that then result in the emission of gamma radiation with signatures 418 and 420, respectively, that may be measured by a detector (not shown) present on a downhole tool that may be the same or a different tool as the tool containing the neutron source. In some embodiments, the neutron source may be located outside of a barrier within the completion system 422, and the high energy particles may then pass through the barrier and sensor housing to irradiate the tracer materials within the sensor in addition to any emitted gamma rays. The gamma radiation signatures may then be used to determine the location of elements 408 and 404 with the completion system and, in some embodiments, with respect to one another.

Gamma ray signatures emitted from tracer materials in accordance with the present disclosure may be obtained from inelastic, capture, or activation gamma radiation. These gamma rays are part of a gamma ray spectrum that is composed of the inelastic, capture and activation gamma ray spectra from all elements in the tool, borehole, casing, and surrounding formation. The contribution of the tracer material may be extracted from the combined signal by a number of techniques. In one or more embodiments, the total gamma ray spectrum may be reconstructed as a sum of standard gamma ray spectra associated with different elements and the relative contributions are calculated. In some embodiments, contributions from inelastic, capture, and activation gamma radiation may be distinguished based on timing of neutron pulses from a pulsed neutron source. Inelastic gamma rays occur most frequently during the neutron burst, while capture gamma rays are present during and after the burst for about 1 ms.

Gamma radiation produced from activation may persist for a relatively long time after neutron irradiation, and may only offer a weak signal. However, activation gamma radiation signals are typically of lower energy and allow better vertical and azimuthal resolution. Depending on the application, the neutron pulsing and the detector arrangement may be optimized for the detection of inelastic, capture or activation gamma rays. Measurement of activation gamma rays in some embodiments may be accomplished by using a gamma ray detector trailing a neutron source at such a distance that no direct neutron induced radiation is observed. The speed at which the neutron source moves may then be adjusted to obtain an optimal activation signal. However, the non-collocation of activation and measurement may require that the tool move at a constant speed. In embodiments in which the neutron source is pulsed, pauses between neutron bursts may be used to measure activation in a certain location without the need for the tool to be moved or allowing the tool to be moved very slowly to scan a depth interval of interest.

In embodiments in which the sensor is designed to measure a threshold pressure, FIG. 4 may represent the sensor prior to experiencing the threshold pressure. However, other sensor configurations are possible and the inclusion of components such as the burst element connecting the mobile and reference components may be optional in some embodiments. On the failure of the burst element 406, the piston 408 is free to move down the receiving chamber. In some embodiments, void space 409 within the receiving chamber may contain a vacuum, a controlled pressure, driving springs, or other mechanisms that may provide an accelerating force to piston 408. In addition, the seal system on the mobile piston element 408 may be designed in a number of ways including, but not limited to, providing a low-friction seal to maximize the piston displacement upon activation, providing a low-friction seal in one direction that prevents reverse movement once the piston is moved, and providing friction in both directions in order to prevent minor forces such as shocks and vibrations to move the piston or trigger the sensor. In one or more embodiments, a sensor may be designed such that the floating piston 408 may be fixed on the low pressure side of a burst element 406, which may provide a primary seal. For example, such a configuration may be useful in HPHT conditions that may limit the use or longevity of polymer seals, and may prevent the completions system from jamming from the presence of unbroken parts of the burst element.

In FIG. 5, the tool is shown after activation to selected stimuli downhole, such as an increase in pressure beyond a threshold value that ruptures the burst element 504. Mobile element travels to the opposing end of the sensor from reference element 502, creating a measurable displacement between the elements. The separation distance between tracer doped elements 504 and 502, may then be measured by exciting the tracer materials contained in the elements with neutron radiation 512, which results in the emission of gamma radiation 510 and 514. Detection of the induced gamma radiation may then be used to measure the displacement of mobile element 506 from reference element 502, signifying that the threshold has been exceeded. In addition to measuring pressure, burst element 406, or equivalently 504, may also be designed such that it degrades in the presence of fluids such as water or oil, or upon exposure to predetermined temperatures or corrosive conditions.

It is noted that the dimensions in FIGS. 4 and 5 are not to scale, and it is envisioned that the receiving chamber 410 may be sized in accordance with demands of the application, which may include the expected logging speed and spatial resolution of the gamma radiation detector employed during measurements. For example, the receiving chamber may be lengthened to enable detection at high logging speeds, where spatial resolution may be degraded in return for faster operations. Moreover, longer receiving chambers may be favored when using the same tracer material in the reference and mobile elements to increase the associated displacement and ability to resolve the individual elements to determine the status change upon exposure to the selected stimulus, e.g., maximum pressure, temperature, chemical exposure, etc.

Wellbore sensors in accordance with the present disclosure may identify a specific condition has existed at some point in the life of a component. In some embodiments, wellbore sensors may detect that pressure above a threshold has occurred, in addition to current and maximum pressure. For example, a wellbore sensor may incorporate a controlled return spring within the receiving chamber, and the location of a piston may be used as a function of the instantaneous applied pressure to provide a measure of current pressure at a point in the completion system. In some embodiments, a second piston may be arranged on the low pressure side of a piston by static friction, such that the second piston moves in response to applied pressure, moving against a return spring, and resisting movement after a decrease in applied pressure. This arrangement may be used to record the maximum pressure experienced by a detector. A third piston may be used as a reference point to the other two pistons to aid measurement of the displacement, in some embodiments. Further, wellbore sensors may involve determining a third parameter such as current pressure, which may require incorporation of a fourth material or the incorporation of a duplicate material. In some embodiments, wellbore sensors may employ a number of different tracer materials in order to distinguish the signal obtained from multiple components, such as a reference, a minimum piston, and a maximum piston, for example.

In one or more embodiments, a sensor may be designed such that sensor incorporates multiple tracer material containing components. In some embodiments, a first tracer material containing component may remain static within a wellbore tool and serve as a point of reference that may be used to determine the relative displacement of one or more other mobile components containing tracer materials. Tracer materials incorporated into the mobile component(s) may contain a tracer material that is identical to that present in the reference component, or may include a different tracer material having a unique gamma radiation emission spectrum such that the characteristic signatures of the reference component and the mobile component may be distinguished, even if collocated. Moreover, the use of differing tracer materials between the reference and mobile component may allow increased spatial resolution (including axial and azimuthal) and sensitivity to component displacement, which may translate to a compact sensor design that occupies less overall axial space.

### Erosion in Valves

In one or more embodiments, tracer materials may be incorporated into a component susceptible to physical wear during operation such that degradation of the component initiates a change in signal when measured after excitation with a neutron device. For example, valve seat erosion may affect the operation of an intelligent completion system, which may occur when a valve is set, yet produces an incorrect choke for the setting due to wear without the operator being aware.

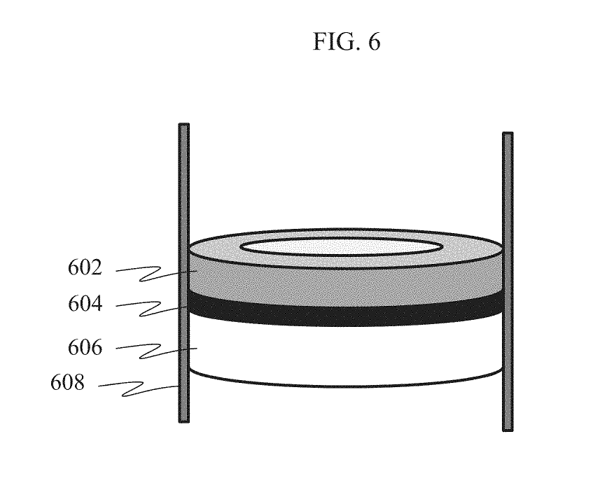

In one or more embodiments, erosion within a completions system may be monitored by placing an amount of tracer element underneath a valve seat, or in a high flow region otherwise susceptible to erosion. For example, tracer materials may be combined with standard valve seats, such as a carbon tungsten-faced valve seat, at the join of the hard-facing and the underlying metal support. With particular respect to FIG. 6, an example of a layered valve seat in accordance with the present disclosure is shown. The modified valve seat may be incorporated within a completions string 608, or wellbore casing in some embodiments, and contain a hardened valve seat face 602, a tracer material containing intermediate layer 604, and, in some embodiments, a support layer 606 composed of a hardened material or other metal. During operation, erosion through the surface layer to the tracer would remove the response of the tracer in a region where it would otherwise be expected, and provide an indication of wear in a given valve. Other applications may include incorporating tracer materials in a valve poppet or other closing face, in which a separate tracer elements could be incorporated in both the poppet and the seat, to verify that the valve is in an open or closed configuration.

### Measurement of Component Wear

In one or more embodiments, tracer material may be formulated as a coating that is applied to a tool component that may be used to measure coating wear on wellbore components such as linear actuators or ball/leadscrews, or otherwise applied to completions components that are expected to experience erosion conditions. In such embodiments, tracer materials may be mixed into a coating directly or encapsulated prior to addition. During operation, the coating could be monitored periodically to verify the presence or absence of the tracer material, which would indicate whether erosion is occurring.

### Measurement of Corrosion

In one or more embodiments, tracer materials in accordance with the present disclosure may be incorporated into a coupon that is installed at one or more points in the completion string. The coupon may be designed such that the coupon degrades in the presence of extremes of temperature, or corrosive materials in some embodiments. For example, the material of the coupon may be selected such that the material degrades at a faster rate than would be expected for other components of the completions systems such as packer elements or valve seats when exposed to fluids such as acids or caustics, abrasive materials, or gases such as carbon dioxide or hydrogen sulfide within the system. In practice, the presence of a coupon could be detected with a neutron tool, in which a diffuse/absent signal would indicate dissolution of coupon due to corrosive conditions.

In one or more embodiments, tracer materials in accordance with the present disclosure may be combined with a polymer coupon and placed at specific points within the completion string. For example, tracer-containing coupons may be used to detect corrosive conditions at specific intervals of the completion string to determine if corrosive wellbore fluids have entered an annular region within the casing or between the casing and formation. Dissolution of the coupon may then be monitored by studying the reduction of induced gamma-ray emission at the coupon location and/or the increased spatial extent. In some embodiments, tracer-containing coupons may be used to estimate the corrosivity of fluids within the completion system. For example, coupons of lower corrosion resistance may be placed at a number of locations in a completion system in order to make early assessments of corrosive conditions and allow time before engaging in a remedial plan.

In one or more embodiments, wellbore sensors in accordance with the present disclosure may be modified such that the burst element (406 or 504, for example) is modified to degrade in the presence of selected chemicals or corrosives, or elevated temperatures encountered by fluids in the completion system. For example, a sealed low-pressure receiving chamber may be employed to apply a controlled force on the floating piston using the ambient downhole pressure. This can then be used to control the stress on a burst element to accelerate or enhance susceptibility of the burst element degradation by crevicing, pitting, or environmental-corrosion cracking. Wellbore sensors designed to detect corrosion may enable early detection of component wear and failure that is often difficult to perceive using corrosion surveys that may vary in effectiveness, which may lead to the occurrence of catastrophic failure, even with little loss of actual material.

In embodiments using a single tracer material, a mobile element may be distinguished from a static reference marker by constructing the reference marker such that it may be constructed with a distinct pattern with depth, intensity, or azimuth that differs from the markers of interest for the measurement.

### Tracer Materials

Wellbore components in accordance with the present disclosure may be modified to contain one or more non-radioactive tracer materials that may be detected when exposed to a neutron source, which in turn produce high-energy gamma radiation characteristic of the particular material. In one or more embodiments, components may be fabricated or doped to contain tracer materials through direct metallurgical inclusion, surface coating with paint or resin compositions, or installed as a doped plug or button before emplacing the tools in a wellbore. Doping to allow flexibility in identification of a particular component during the installation process. For example, a component such as a given liner join may be labelled using a tracer element tag for ease of location as a target for a multi-lateral window exit later. In one or more embodiments, the doped components may be configured away from electronic modules, such that the neutron flux for activation, and resultant radioactivity does not damage nearby electronics.

In some embodiments, tracer materials may include elements that emit gamma radiation following irradiation with a neutron tool such as barium, cerium, praseodymium, or lead. Further, isotopes inelastic reactions may also result in activation products, some embodiments may also employ isotopes, which produce gamma rays other than (or in addition to) the 511-keV annihilation gamma rays that may be characteristic of a selected tracer material.

Furthers, tracer elements may include elements that are uncommon in metallurgy often employed in the construction of steels, inconels, and corrosion resistance alloys used in completion system components such as iron, nickel, chromium, cobalt, copper, manganese, niobium and carbon. In some embodiments, it may be possible to use the detection of inelastic gamma rays by using materials with a large inelastic interaction cross section, such as ⁶³Cu(n,2n)⁶²Cu, ¹⁴¹Pr(n,2n)¹⁴⁰Pr, ¹⁴⁰Ce(n,2n)¹³⁹Ce, and ²⁸Si(n,p)²⁸Al. In particular embodiments, the system may be modified such that the tracer materials may include detecting copper or iron present in downhole cables or components.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A method of detecting the presence of a component in a wellbore comprising:
irradiating an interval of a wellbore containing one or more components of a wellbore tool with a neutron source, wherein the one or more components of the wellbore tool comprise one or more tracer materials;
measuring the radiation emitted from the one or more components of a wellbore tool; and
determining one or more of presence, location, and intensity of the radiation emitted from the one or more components of the wellbore tool.

2. The method of claim 1, wherein the neutron source is a pulsed neutron generator.

3. The method of claim 1, wherein the wellbore tool comprises a first component containing one or more tracer materials and a second component containing one or more tracer materials, wherein the one or more tracer materials in the first component are different than the one or more tracer materials in the second component.

4. The method of claim 1, wherein the wellbore tool comprises at least two tracer materials, and wherein the at least two tracer materials are selected such that the radiation emitted following irradiation from the neutron source have unique signatures such that the presence of each of the tracer materials may be detected even when colocalized.

5. The method of claim 1, wherein the one or more tracer materials are selected from a group consisting of: barium, cerium, praseodymium, and lead.

6. The method of claim 1, wherein the one or more tracer materials are selected from a group consisting of: boron, cadmium, gadolinium, and lithium.

7. The method of claim 1, wherein determining one or more of presence, location, and intensity of the radiation emitted from the one or more components of the wellbore tool comprises using a detector to measure the thermal neutron capture cross section of the material surrounding the tool, wherein an increased capture cross section is indicative of the presence of one or more of the components.

8. The method of claim 1, wherein determining one or more of presence, location, and intensity of the radiation emitted from the one or more components of the wellbore tool comprises detecting the radiation emitted from the one or more components of a wellbore tool using an azimuthally sensitive detector.

9. The method of claim 1, wherein determining one or more of presence, location, and intensity of the radiation emitted from the one or more components of the wellbore tool comprises determining a maximum or minimum pressure experienced by the one or more components of the wellbore tool.

10. The method of claim 1, wherein determining one or more of presence, location, and intensity of the radiation emitted from the one or more components of the wellbore tool comprises determining the presence of corrosive conditions.

11. The method of claim 1, wherein the one or more tracer materials are associated with the one or more wellbore components by one or more selected from a group consisting of: forming the one or more components from an alloy of a metal and the one or more tracer materials, coating the one or more wellbore components with one or more tracer materials, and installation of one or more tracer materials into the one or more wellbore components as a layer, a doped slug, a button, or by ion injection.

12. A device comprising:
a first element comprising one or more tracer materials, wherein the one or more tracer materials emit gamma radiation upon irradiation with a neutron source;
wherein the tool is configured to be emplaced in a subterranean formation.

13. The device of claim 12, wherein the one or more tracer materials are selected from a group consisting of: barium, cerium, praseodymium, lead, boron, cadmium, gadolinium, and lithium.

14. The device of claim 12, further comprising a second element comprising one or more tracer materials.

15. The device of claim 14, further comprising a burst element connecting the first element and the second element.

16. The device of 15, wherein the burst element is designed to degrade in the presence of one or more of a group consisting of: temperature, water exposure, hydrocarbons, and pH change.

17. The device of claim 15, further comprising a third element comprising one or more tracer materials.

18. The device of claim 12, wherein the first element comprising one or more tracer materials is configured within a receiving chamber;
wherein the tool further comprises a second element comprising one or more tracer materials that is statically configured in the receiving chamber;
wherein the tool further comprises a burst element fixedly connected to both the first element and the second element; and
wherein degradation of the burst element mobilizes the first element, allowing the first element to travel some distance from the second element in the receiving chamber, such that the displacement of the first element with respect to the second element is measurable by irradiating the first element and the second element with a neutron source, and detecting the radiation emitted.

19. The device of claim 12, wherein the first element is a valve seat.

20. The device of claim 19, wherein a second element comprises a valve element, poppet or moveable sealing component.
